(19) United States
(12) Patent Application Publication
(10) Pub. No.: US 2026/0146859 A1
(43) Pub. Date: May 28, 2026

(54) METHOD AND SYSTEM FOR VOICE GUIDANCE IN NAVIGATION

(71) Applicant: HYUNDAI AUTOEVER CORP., Seoul (KR)

(72) Inventors: Jin Young Han, Seoul (KR); Jung Eun Kim, Seoul (KR); Won Heung Jo, Seoul (KR); Gang Seok Suh, Seoul (KR); Moon Jeong Kim, Seoul (KR)

(73) Assignee: HYUNDAI AUTOEVER CORP., Seoul (KR)

(21) Appl. No.: 19/310,679

(22) Filed: Aug. 26, 2025

(30) Foreign Application Priority Data
Nov. 26, 2024 (KR) 10-2024-0171237

(51) Int. Cl. G01C 21/36; G06F 3/04845; G06F 3/0488; G06F 3/16; G10L 21/0216

(52) U.S. Cl. CPC G01C 21/3629; G06F 3/04845; G06F 3/0488; G06F 3/167; G10L 21/0216; G06F 2203/04806

(57) ABSTRACT

A navigation voice guidance method, performed by a navigation terminal including a touch display, includes outputting a voice guidance. The navigation voice guidance method also includes identifying a first user input based on a predefined touch input on the touch display. The navigation voice guidance method additionally includes re-outputting the voice guidance in response to the first user input.

### CROSS-REFERENCE TO RELATED APPLICATION

This application claims the benefit of and priority to Korean Patent Application No. 10-2024-0171237, filed on Nov. 26, 2024, the entire contents of which are hereby incorporated herein by reference.

### TECHNICAL FIELD

The present disclosure relates to a navigation voice guidance method and system, and more specifically, to a navigation voice guidance method and system that support a user in not missing important guidance.

### BACKGROUND

In modern society, in-vehicle navigation systems have been continuously evolving not only to guide drivers to a destination but also to provide a safe and convenient driving environment. During driving, voice guidance enables drivers to obtain necessary information without relying on visual cues, thereby improving driving safety. In particular, in complex road conditions or congested traffic sections, information such as route change guidance, lane change guidance, and warnings about hazardous areas should be delivered in real time. Missing such information may cause drivers to enter incorrect routes or fail to take necessary driving actions.

Existing navigation systems focus primarily on guiding routes and destinations and provide limited functionality for re-outputting guidance voice, and may cause inconvenience to drivers by offering voice guidance without considering the drivers'intention or surrounding environments. For example, on a noisy road, a driver may miss voice guidance and thus fail to follow the route, and if the navigation system does not have an automatic re-output function or provides it only in a limited manner, the driver may be unable to replay the voice guidance.

Moreover, with the advancement of driver-assistance systems, drivers are now able to engage in non-driving-related tasks (NDRTs), and it has become important to quickly recognize take-over requests (TORs) during emergencies. However, conventional navigation systems are unable to assess drivers'attentiveness or noise levels, and thus may fail to provide appropriate voice guidance even in emergency situations.

### SUMMARY

Embodiments of the present disclosure provide a method and system that support a user in continuing safe driving without deviating from the route by re-outputting navigation voice guidance missed during driving through a simple gesture input.

Embodiments of the present disclosure provide a method and system that ensure important voice guidance is effectively delivered without being hindered by noise, by detecting (e.g., automatically detecting) and analyzing various internal and external noise environments.

Embodiments of the present disclosure provide a method and system that recognize a user's intention to interrupt voice guidance through their behavior or speech, and reduce unnecessary guidance, thereby providing a personalized navigation environment that allows the user to drive more comfortably.

Embodiments of the present disclosure provide a method and system that evaluate the importance of specific navigation voice guidance and re-output important guidance that may affect the current route, so that the user does not miss critical instructions.

The objectives of the present disclosure are not limited to those mentioned above. Oher objectives not explicitly stated herein should be more clearly understood by those having ordinary skill in the art from the following description.

According to an embodiment of the present disclosure, a navigation voice guidance method, performed by a navigation terminal including a touch display, is provided. The navigation voice guidance method includes outputting a voice guidance. The navigation voice guidance method also includes identifying a first user input based on a predefined touch input on the touch display. The navigation voice guidance method also includes re-outputting the voice guidance in response to the first user input.

Identifying the first user input may include detecting that a first point on the touch display is moved to a second point located at the lower left of the first point, and detecting that the second point is moved to a third point located at the lower right of the second point.

Identifying the first user input may include detecting that a user zooms in on a screen of the touch display within a predefined period after output of the voice guidance.

The navigation voice guidance method may further include identifying an intention of a user to stop the re-output of the voice guidance and stopping re-output of the voice guidance in response to identifying the intention of the user to stop the re-output of the voice guidance. The intention to stop the re-output of the voice guidance may be identified based on a behavior or utterance of an occupant of a mobility device.

The navigation voice guidance method may further include displaying re-output-related information as a popup on a mobility navigation screen together with re-output of the voice guidance.

According to another embodiment of the present disclosure, a navigation voice guidance method, performed by a navigation terminal, is provided. The navigation voice guidance method includes outputting a voice guidance, determining a level of noise at a time of output of the voice guidance, determining whether to re-output the voice guidance based on the level of noise, and re-outputting the voice guidance based on determining that the voice guidance is to be re-output.

Determining whether to re-output the voice guidance may include evaluating a behavior or utterance of an occupant of a mobility device equipped with the navigation terminal during a predetermined period from the time of the output of the voice guidance, and determining whether to re-output the voice guidance based the behavior or utterance of the occupant and the level of noise.

Determining whether to re-output the voice guidance may include determining an importance level of the voice guidance, and determining to re-output the voice guidance based on determining that the importance level of the voice guidance is a first importance level. The importance level may include the first importance level and a second importance level lower than the first importance level. The importance level may be determined based on a degree of influence on a real-time route.

The navigation voice guidance method may further include identifying an intention of a user to stop the re-output of the voice guidance, and stopping the re-output of the voice guidance in response to identifying the intention to stop the re-output of the voice guidance. The intention to stop the re-output of the voice guidance may be identified based on a behavior or utterance of an occupant of a mobility device.

The navigation voice guidance method may further include displaying re-output-related information as a popup on a mobility navigation screen together with the re-output of the voice guidance.

Re-outputting the voice guidance may include performing a noise suppression measure, and re-outputting the voice guidance together with the noise suppression measure. The noise may include external noise and internal noise. A noise suppression measure for the external noise and a noise suppression measure for the internal noise may be distinguishable from each other.

According to yet another embodiment of the present disclosure, a navigation voice guidance system is provided. The navigation voice guidance system includes at least one processor; and a memory storing computer-readable instructions that, when executed by the at least one processor, cause the at least one processor to output a voice guidance; identify a first user input based on a predefined touch input on the touch display, and re-output the voice guidance in response to the first user input.

According to still another embodiment of the present disclosure, a navigation voice guidance system is provided. The navigation voice guidance system includes at least one processor and a memory storing computer-readable instructions that, when executed by the at least one processor, cause the at least one processor to outputting a voice guidance, determine a level of noise at a time of output of the voice guidance, determine whether to re-output the voice guidance based on the level of noise, and re-output the voice guidance based on determining that the voice guidance is to be re-output.

The effects of the present disclosure are not limited to the effects described above. Other effects of the present disclosure not mentioned herein should be more apparent to those of ordinary skill in the art from the following description.

### BRIEF DESCRIPTION OF THE DRAWINGS

The above and other aspects and features of the present disclosure should become more apparent from the following detailed description taken in conjunction with the accompanying drawings, in which:

FIG. 1 is a diagram illustrating a navigation voice guidance system according to an embodiment of the present disclosure;

FIG. 2 is a diagram illustrating an in-vehicle navigation terminal according to an embodiment of the present disclosure;

FIG. 3 is a diagram illustrating a handwriting-based gesture input on the touch display of the navigation terminal according to an embodiment of the present disclosure, in which a user requests re-output of voice guidance;

FIG. 4 is a diagram illustrating a process in which the user adjusts the scale of a map or route in the navigation terminal according to an embodiment of the present disclosure;

FIG. 5 is a diagram illustrating a process in which driving-related information is displayed in a popup format on a navigation screen according to an embodiment of the present disclosure;

FIG. 6 is a flowchart illustrating a process in which the navigation terminal detects noise and determines whether to re-output guidance information according to an embodiment of the present disclosure;

FIG. 7 is a flowchart illustrating a process in which voice guidance is output and re-output through user input in a navigation terminal according to an embodiment of the present disclosure;

FIG. 8 is a flowchart illustrating a process in which the user indicates an intention to interrupt re-output voice guidance after the re-output of the voice guidance, according to an embodiment of the present disclosure;

FIG. 9 is a flowchart illustrating a process in which relevant information is displayed on a navigation screen after the re-output of the voice guidance, according to an embodiment of the present disclosure;

FIG. 10 is a flowchart illustrating a process in which a navigation terminal automatically determines whether to re-output voice guidance according to an embodiment of the present disclosure;

FIG. 11 is a flowchart illustrating a process of determining whether to re-output the voice guidance according to an embodiment of the present disclosure;

FIG. 12 is a flowchart illustrating a process of determining whether to re-output the voice guidance according to another embodiment of the present disclosure;

FIG. 13 is a flowchart illustrating a process of re-outputting the voice guidance according to an embodiment of the present disclosure;

FIG. 14 is a flowchart illustrating a process of re-outputting the voice guidance according to another embodiment of the present disclosure; and

FIG. 15 is a block diagram illustrating a hardware configuration of a computing device for navigation voice guidance according to an embodiment of the present disclosure.

### DETAILED DESCRIPTION

Hereinafter, embodiments of the present disclosure are described in detail with reference to the accompanying drawings. The advantages and features of the present disclosure, and methods for achieving them, should be more clearly understood by referring to the embodiments described below in detail in conjunction with the accompanying drawings. However, the present disclosure is not limited to the embodiments described herein and may be implemented in various different forms. The embodiments are provided merely to ensure completeness of the present disclosure and to fully enable those having ordinary skill in the art to make and utilize the described embodiments of the present disclosure, as well as various alternatives and modifications thereof. The present disclosure is defined only by the scope of the claims and equivalents thereof.

In assigning reference numerals to components in the drawings, it should be noted that the same reference numerals are used for the same components, as much as possible, even if the components appear in different drawings. In addition, in the present disclosure, where it was determined that a detailed description of related known components or functions would obscure the gist of the present disclosure, the detailed description thereof.

Unless otherwise defined, all terms, including technical and scientific terms, used in this specification should be construed to have meanings commonly understood by one of ordinary skill in the art to which the present disclosure pertains. Terms that are generally defined in commonly used dictionaries should not be interpreted ideally or excessively unless explicitly defined otherwise or apparent from the context. The terms used in this specification are intended to describe the embodiments and are not intended to limit the scope of the present disclosure. In this specification, the singular includes the plural unless specifically stated otherwise.

In addition, in describing the components of the present disclosure, terms such as first, second, A, B, (a), (b), and the like may be used. These terms are merely used to distinguish one component from another, and the nature, order, or sequence of the components is not limited by the terms. When it is stated that one component is “connected,” “coupled,” or “joined” to another component, it should be understood that the component may be directly connected or joined to the other component, but another component may also be “connected,” “coupled,” or “joined” in between them.

As used in this specification, the terms “includes”, “including”, “comprises”, “comprising”, or the like, do not exclude the presence or addition of one or more other components, steps, operations, and/or elements in addition to the ones mentioned.

When a component, controller, device, element, apparatus, unit, or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, and the like may separately embody or be included with a processor and a memory, such as a non-transitory computer readable media, as part of the apparatus.

Throughout the present disclosure, the term “mobility device” encompasses various types of vehicles that allow a driver or passenger to travel, and a representative example is an automobile with autonomous driving capabilities. Such a mobility device may autonomously travel to a destination or adjust the driving route based on user input, and may be capable of selecting different driving modes depending on road conditions or driving environments. In particular, an autonomous vehicle may recognize its surroundings in real time using sensors, cameras, LiDAR, and the like, and determine a route for safe driving. In addition, the term “mobility device” may also encompass personal mobility means such as electric scooters and bicycles.

Also throughout the present disclosure, “touch-based user input” refers to a method in which a user writes characters directly on a screen or inputs a specific pattern using a finger or an input tool such as a stylus. For example, the user may touch the screen and, while maintaining the touch, move the touch point to input a shape such as “<,” and such input may be recognized as a single continuous operation. The same type of input may also be performed with a stylus. The touch-based user input referred to throughout the present disclosure may include handwriting-based touch input. Additionally, the term “move” as used in this specification may include the concept of “drag.” Moving after touching may refer to movement of the touch point without lifting the point of contact from the screen.

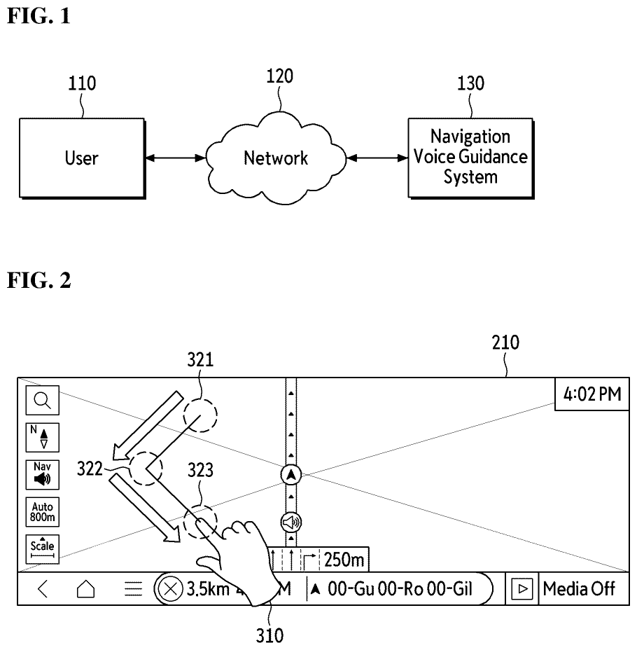

FIG. 1 is a diagram illustrating a navigation voice guidance system according to an embodiment of the present disclosure.

Referring to FIG. 1, a user 110 may use a navigation service through an in-vehicle digital device or a mobile device. The user 110 may generally be an entity requiring navigation guidance. The user 110 may be connected to a navigation voice guidance system 130 via a network 120 and may receive various types of guidance such as voice guidance and route information in real time. The user 110 may include, for example, a passenger or the driver of a mobility device.

The network 120 is a communication network that enables data communication between the user 110 and the navigation voice guidance system 130. The network 120 may include various wired or wireless communication technologies such as a wireless communication network, a mobile communication network, and Wi-Fi. The network 120 may support data transmission between the user 110 and the navigation voice guidance system 130 to allow real-time delivery of voice guidance information and driving-related information.

The navigation voice guidance system 130 is a system that performs voice guidance based on a request received from the user 110 or data transmitted via the network 120. The navigation voice guidance system 130 may provide necessary driving information based on the current location and route of the user 110. In an embodiment, the navigation voice guidance system 130 may gave a function of re-outputting voice guidance according to a request of the user 110 and/or surrounding noise environment. The user 110 (e.g., the driver of the mobility device) may thus effectively perceive necessary information without missing route guidance during driving.

Accordingly, in an embodiment, the navigation voice guidance system 130 interacts with the user 110 in real time through the network 120, and constitutes a system that supports voice guidance and re-output functions to provide the user 110 with an optimal driving experience.

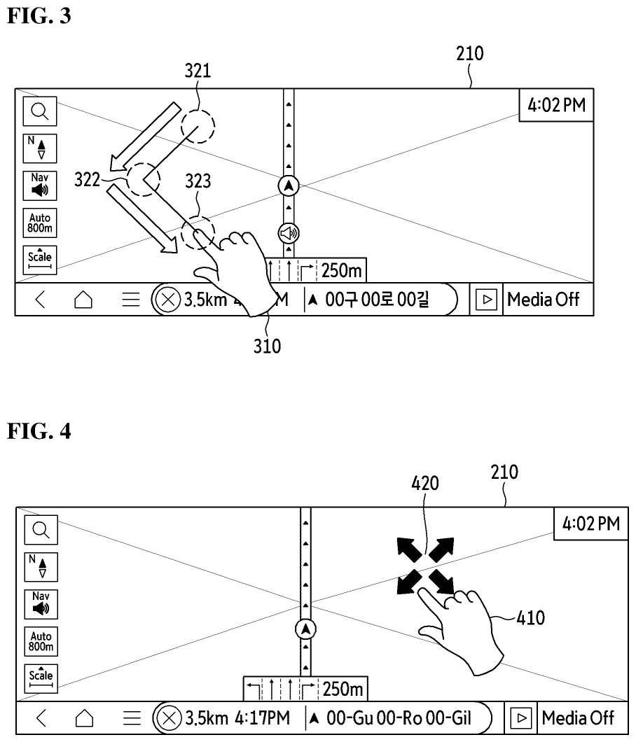

FIG. 2 is a diagram illustrating an in-vehicle navigation terminal according to an embodiment of the present disclosure.

Referring to FIG. 2, a navigation terminal 210 includes a touch display that allows the user 110 to directly perform various inputs through touch. In an embodiment, the navigation terminal 210 supports the output and re-output of voice guidance and displays driving information such as routes and maps so that the user 110 (e.g., the driver) may immediately check necessary information while driving.

The touch display of the navigation terminal 210 may recognize user input where the user 110 may request re-output of voice guidance by drawing a specific gesture or entering a touch pattern. The user 110 may also manipulate the screen, such as by enlarging or reducing the scale of a route or map through touch. In an embodiment, information related to route guidance, a map, or re-output of voice guidance may be displayed on the screen as a popup, providing the user 110 with intuitive guidance.

In some embodiments, the navigation terminal 210 may be equipped with a device such as a microphone and/or a camera, that may recognize the behavior or speech of a passenger in the mobility device to determine whether to re-output voice guidance. The microphone may also identify external and internal noise, and may perform a noise suppression measure if necessary. The noise suppression measure may distinguish between internal and external noise and respond to each accordingly, and a noise canceling function may be used to suppress external noise.

The noise suppression measure may be performed by the navigation terminal 210 itself or by another device in the mobility device. In an embodiment, the entity performing the noise suppression may be a component attached to the navigation terminal 210.

FIG. 3 is a diagram illustrating a handwriting-based gesture input on the touch display of the navigation terminal according to an embodiment of the present disclosure, in which the user requests re-output of voice guidance.

The navigation terminal 210 may include a touch display and may perform a voice guidance re-output function through intuitive user input.

Referring to FIG. 3, an input entity 310, represented by a hand, may correspond to the user 110, who may be the driver or a passenger of the mobile device. The user 110 may input a command into the navigation terminal 210 using a finger, multiple fingers, or various touch input devices. Although FIG. 3 illustrates an example of entering input using a single finger, this is merely an example, and the present disclosure is not limited thereto. For example, other input means such as multiple fingers or a stylus may be used, in some embodiments.

In an embodiment, the user 110 is provided with a function of receiving re-output of voice guidance through direct handwriting input on a map. In an embodiment, a backward symbol in the intuitive shape of “<” may be provided a handwriting method for requesting re-guidance. The user 110 may request re-output of voice guidance by drawing a “<” shaped gesture on the screen of the navigation terminal 210, thereby allowing the user 110 to listen again to the voice guidance with a simple and intuitive operation.

FIG. 3 illustrates the “<” shaped gesture as an example. The drawn gesture may be defined in various forms other than “<,” as long as it has a shape that can be intuitively input by the user 110. In an embodiment, the handwriting input for satisfying a re-guidance condition may be limited to cases in which the user 110 draws, drags, or touches and moves without lifting the touch point, so that the drawn gesture is recognized as a return gesture.

In the illustrated embodiment, during the input of the “<” shaped gesture, a first point 321 indicates the location where the user 110 starts a first touch. Starting from the first point 321, the user 110 moves the touch point to the lower left to reach a second point 322. Then, from the second point 322, the user 110 moves the touch point toward the lower right to reach a third point 323, thereby completing the input of the “<” shaped gesture. This series of actions allows the user 110 to request re-output of voice guidance through a predefined form of handwriting input.

In an embodiment, the handwriting range may be limited to the visible area on the touch display of the navigation terminal 210.

Accordingly, FIG. 3 illustrates a function in which the user 110 intuitively requests re-output of voice guidance through a handwriting-based gesture on the navigation terminal 210. Through this function, when the user 110 misses important guidance, the user 110 may listen to the voice guidance again with a simple gesture input, thereby ensuring convenience and safety during driving.

FIG. 4 is a diagram illustrating a process in which the user adjusts the scale of a map or route in the navigation terminal according to an embodiment of the present disclosure.

The navigation terminal 210 may include a touch display, and the user 110 may enlarge or reduce a map through the touch display to check driving information in greater detail.

Referring to FIG. 4, an input entity 410, represented by a hand, may correspond to the user 110, who may be the driver or a passenger of the mobile device. The user 110 may input a command into the navigation terminal 210 using a finger, multiple fingers, or various touch input devices. Although FIG. 4 illustrates an example using a single finger, this is merely an example, and the present disclosure is not limited thereto. For example, various input means such as multiple fingers or a stylus may be used, in some embodiments. The user 110 may adjust the scale of a map or route displayed on the screen of the navigation terminal 210 through the input entity 410.

Symbol 420 represents the enlargement or reduction of the map scale in a schematic manner, visually indicating the zooming operation on the map performed by the user 110. The form presented in FIG. 4 is merely an example, and the present disclosure is not limited thereto. For example, the map scale may be adjusted through various other icons or gestures, in some embodiments. The navigation terminal 210 receives such user input and adjusts the map scale accordingly, thereby providing the user 110 with desired information in a timely manner.

In an embodiment, when the user 110 is unable to clearly hear voice guidance, for example, due to surrounding noise or other reasons, the user 110 may tend to enlarge the scale of the map to check the current driving route in more detail. The user 110 may thus verify whether the user 110 is currently following the correct route and may pre-check information such as the route ahead or intersections to re-confirm the driving direction. This scale enlargement function may play an important role in helping the user 110 eliminate uncertainty while driving and safely reach the destination.

In an embodiment, when the user 110 manually enlarges the map scale within a preset period after the end of voice guidance, re-guidance may be performed. This may serve as a condition to prevent unintentional re-guidance. The preset period may be, for example, 10 seconds after the end of the voice guidance.

In relation to FIG. 4, in some cases, the map scale may be reduced to return to the previous screen after re-guidance. This may reflect the intention that it is unnecessary to maintain an enlarged navigation screen after re-guidance has been completed.

Also, in some cases, re-guidance may be performed only when the user 110 attempts to drag after enlarging the map scale. This may also serve as a condition to prevent re-guidance from being performed contrary to the intention of the user 110.

Accordingly, FIG. 4 illustrates a process in which the user 110 adjusts the scale of a map or route using the touch display of the navigation terminal 210. This may be a function that allows the user 110 to effectively check and utilize necessary information during driving, thereby improving driving convenience and safety.

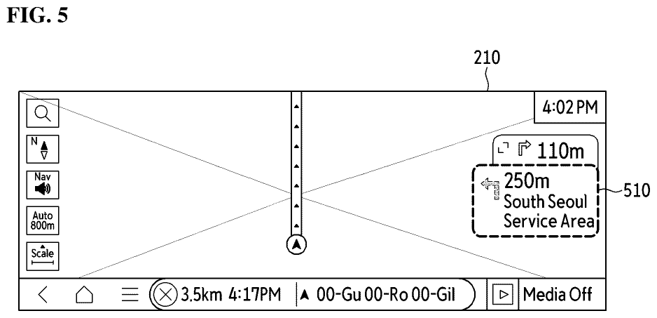

FIG. 5 is a diagram illustrating a process in which driving-related information is displayed as a popup on the screen of the navigation terminal according to an embodiment of the present disclosure.

The navigation terminal 210 includes a touch display, and the driver may visually check various types of driving information through the touch display.

Referring to FIG. 5, a popup 510 may be a highlighted popup displaying information related to driving. The popup 510 includes, for example, guidance that reads “Turn left in 250 m toward southwest”. Such popup-form information intuitively provides important information to the driver during driving, helping the driver not to miss details of the route. In addition to driving-related information, the popup 510 may also display information related to re-guidance when voice guidance has been re-output. For example, during re-output, a notification that reads “Re-guidance has started” may appear as a popup to inform the user 110 of the re-guidance status.

This popup-form information may be displayed simultaneously with the re-output of voice guidance, thereby improving driving safety by providing visual supplementary information when the user 110 misses voice guidance. As described above with reference to FIGS. 3 and 4, the user 110 may request re-output of voice guidance through a specific gesture or input. In an embodiment, when the user 110 expresses the intention to stop re-output, both the voice guidance and the display of the popup 510 may be stopped together.

The intention to stop re-output may be identified based on the driver's behavior or voice utterance. For example, if the driver utters a command, e.g., “Stop it” or “Don't say it again,” the navigation terminal 210 may recognize the command as the intention to stop re-output and stop the voice guidance and the display of the popup 510. In addition, if the user deactivates an automatic re-guidance function, voice guidance re-output may no longer be performed. In this case, the automatic re-guidance function may be configured to be reset whenever the vehicle is started, or may remain deactivated regardless of whether the ignition is turned on or off, depending on preference of the user 110.

In an embodiment, along with the display of the highlighted popup 510, a re-prompt button may be provided. In this case, the re-prompt button may be provided at the location on the route line where the most recent voice guidance has been output. This may be to provide a function that allows additional re-guidance to a user 110 who wishes to hear re-guidance again after the initial re-guidance. The re-prompt button may be provided in an on-screen display (OSD) popup.

Accordingly, FIG. 5 illustrates a system in which various driving information is provided in popup form on the screen of the navigation terminal 210, effectively delivering real-time guidance to the user 110 during driving, and describes a flexible guidance system in which the user 110 can re-output or stop voice guidance as needed.

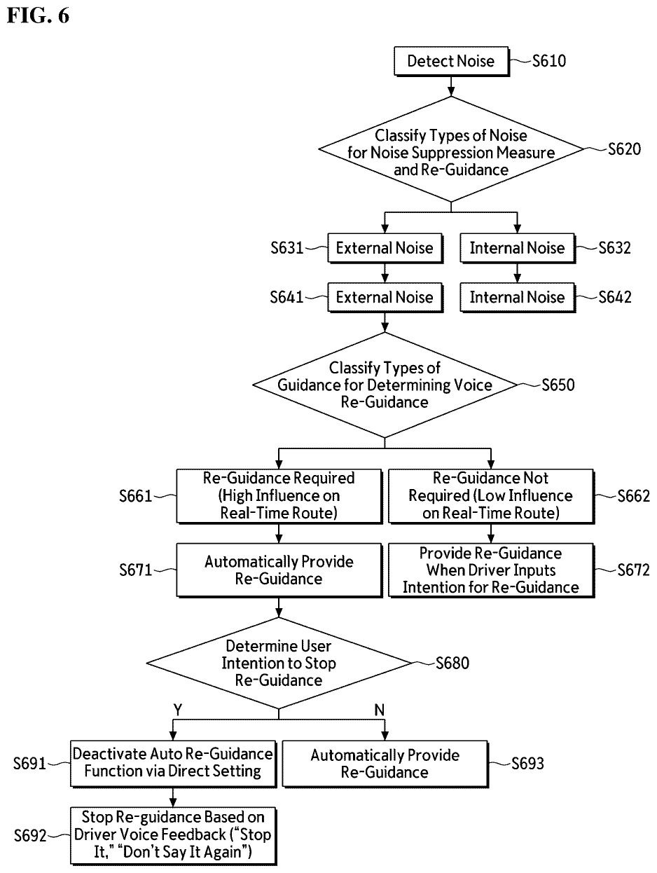

FIG. 6 is a flowchart illustrating a process in which a navigation terminal detects noise and determines whether to re-output guidance information according to an embodiment of the present disclosure.

Referring to FIG. 6, in a step or operation S610, various types of noise generated inside and outside a vehicle may be detected. Both external and internal noise may be collected through a noise detection sensor. The external noise may include road noise, wind noise, tire noise, engine noise, traffic noise, natural noise, construction noise, and other external noise. The internal noise may include engine noise, tire-ground contact noise, wind noise caused when windows are open, vibration noise from vehicle parts, air conditioner and heater noise, conversation noise from passengers, noise from audio devices, noise from doors and windows, and noise from interior materials. The step or operation S610 provide base data for a noise suppression measure and determination of the necessity for re-guidance by classifying noise in detail.

In a step or operation S620, the detected noise may be classified into external noise and internal noise. The external noise includes various types of noise generated in the vehicle's external environment. Road noise may include noise from asphalt or concrete roads, and traffic noise may include noise from vehicles, bicycles, pedestrians, and other transportation means. In addition, there may be natural noise caused by weather factors such as rain or wind, construction or construction site noise, and other external noise such as horn sounds or lawnmower noise. The internal noise may include mechanical noise generated during engine operation, tire-ground contact noise, wind noise felt when windows are open, noise from air conditioning or audio systems, passenger conversation noise, and friction noise from interior materials. By classifying the detected noise in this manner, base data suitable for a noise suppression measure and re-guidance determination may be provided.

In a step or operation S631, an external noise suppression measure may be performed. For example, noise canceling technology may be used to suppress wind, tire, or engine noise. This may allow the driver to clearly hear important guidance and ensure critical information is not masked by external noise during driving.

In a step or operation S632, an internal noise suppression measure may be performed to reduce internal noise. The internal noise suppression measure suppression measure prevents various types of noise generated inside the vehicle from interfering with voice guidance. For example, air conditioner noise, audio system noise, or passenger conversation noise may be reduced when necessary. This may help create an environment in which the driver can clearly hear voice guidance.

In a step or operation S650, the necessity of re-guidance may be determined based on the type of voice guidance. Information for which re-guidance is necessary includes, for example, guidance for highway entry, entry onto or exit from major roads, turning left or right at intersections, real-time traffic information (e.g., accidents, construction, traffic congestion, etc.), speed limit information for specific sections, and warnings for hazardous areas such as slippery roads, steep slopes, and school zones. Such information may substantially affect driving, and therefore repeated guidance may need to be provided to the driver. In contrast, information for which re-guidance is not necessary includes, for example, road name guidance, destination arrival guidance, voice recognition features, vehicle setting guidance, parking guidance, and route change guidance. Since this information does not significantly affect the driving route, minimizing unnecessary repeated guidance may help maintain driver concentration.

In a step or operation S661, when it is determined that re-guidance is necessary, the navigation terminal may provide re-guidance for important information such as highway entry, intersection turns, real-time traffic information, speed limit guidance, and hazardous area warnings. The step or operation S661 may help ensure that the driver can recognize important information in a timely manner while driving.

In a step or operation S662, when it is determined that re-guidance is not necessary, information that does not significantly affect the driving route, such as road name guidance, parking guidance near the destination, and vehicle setting guidance, may not be re-output. This may help prevent confusion caused by unnecessary re-guidance and allow the driver to use attention efficiently.

In a step or operation S671, when it is determined that re-guidance is necessary, the navigation terminal may automatically perform re-guidance. For example, in a situation where real-time information is important, such as at an intersection or highway on-ramp, the navigation terminal may automatically perform re-guidance to ensure important guidance is not missed.

In a step or operation S672, when the driver directly requests re-guidance, re-guidance may be provided. The user may listen to necessary information again through a return gesture or a re-guidance button, thereby supporting the driver in not missing important information.

In a step or operation S680, when re-guidance is in progress and the driver expresses an intention to stop it, such intention may be recognized. If the driver issues a voice command, e.g., “Stop it” or “Don't say it again,” to request stopping re-guidance, the navigation terminal may recognize the voice command as a signal to stop the re-guidance and may stop re-outputting accordingly.

In a step or operation S691, the driver may directly deactivate the automatic re-guidance function. If the automatic re-guidance function is deactivated, re-guidance may no longer be performed. The setting of the automatic re-guidance function may be retained depending on the user's preferences. The setting of the automatic re-guidance function may be maintained even after restarting the vehicle, or the automatic re-guidance function may be reset based on user preference.

A step or operation S692 corresponds to a case in which the driver requests to stop re-guidance through voice feedback. For example, if the driver provides voice feedback such as “Stop it” or “Don't say it again,” the navigation terminal may recognize the voice feedback and stop re-guidance. This may help reduce driver fatigue caused by unnecessary repeated guidance.

In a step or operation S693, if no stop intention is detected, the navigation terminal may continue re-guidance automatically. In an embodiment, the step or operation S693 is intended to help the driver maintain driving without missing important information and to improve safety and efficiency through repeated guidance of important information.

As described above, FIG. 6 illustrates how the navigation terminal may detect and classify noise and selectively re-output only necessary guidance information, thereby supporting the driver in clearly recognizing and utilizing necessary information even while driving.

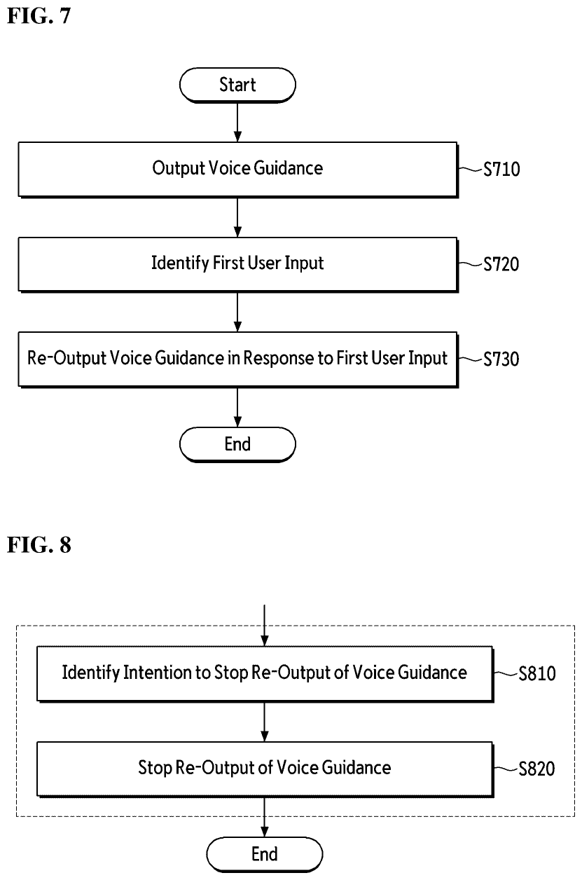

FIG. 7 is a flowchart illustrating a process in which voice guidance is output and re-output through user input in the navigation terminal according to an embodiment of the present disclosure.

FIG. 7 illustrates a method by which the navigation terminal interacts with the user through a touch display and efficiently provides necessary guidance during driving.

Referring to FIG. 7, in a step or operation S710, the navigation terminal may output voice guidance. This voice guidance may serve to deliver necessary information to the driver along the driving route and may include various types of guidance such as turning left, turning right, and guidance near the destination. Such voice guidance may be provided in real time according to road conditions and may assist the driver in following the route.

In a step or operation S720, a first user input may be identified. For example, the user may perform a specific gesture input through the touch display of the navigation terminal. The navigation terminal may identify a first user input based on a predefined touch input on the touch display. For example, if the user inputs a “<” shaped gesture on the touch display, the navigation terminal may recognize it as an input requesting re-output of voice guidance. In this case, the gesture may include a touch movement extending from a first point to a second point and then to a third point. Throughout the present disclosure, a touch movement may include a drag operation.

In a step or operation S730, in response to the first user input being identified in the step or operation S720, voice guidance may be re-output. This may be useful in a situation where the driver has missed the voice guidance or desires additional guidance. At the same time, information related to the re-output may be displayed in popup form on a mobility navigation screen (the screen of the navigation terminal?). The driver may thus not only hear the voice guidance again but also visually confirm information regarding the current position or driving direction, thereby improving driving convenience.

The flowchart in FIG. 7 describes a method in which the navigation terminal provides voice guidance and re-outputs it in response to the user's touch input, allowing necessary information to be intuitively provided during driving. This method may support the driver in easily listening to voice guidance again even when the voice guidance has been missed or not clearly heard due to noise, thereby contributing to safe and convenient driving.

FIG. 8 is a flowchart illustrating a process in which the user indicates an intention to stop the re-output of voice guidance after the step or operation S730 in FIG. 7, according to an embodiment of the present disclosure.

Referring to FIG. 8, the navigation terminal may provide a function that recognizes the user's intention to stop voice guidance and terminates the re-output of voice guidance accordingly.

In a step or operation S810, a process of identifying whether the user expresses an intention to stop the re-output of voice guidance may be performed. The user may request to stop the re-output of voice guidance through a voice command or a specific gesture, or by selecting a button on the touch display. For example, the driver may clearly express the intention to stop re-output using a voice command, e.g., “Stop it” or “Don't say it again,” and the navigation terminal may detect and recognize such intention.

In a step or operation S820, in response to the user's stop request identified in the step or operation S810, the re-output of voice guidance may be immediately stopped. The step or operation S820 may provide a function to prevent the driver from feeling discomfort due to unnecessary repeated guidance. For example, the navigation terminal may immediately stop the re-output of voice guidance so that the voice guidance does not become a distraction once the driver has sufficiently understood the content of the voice guidance.

Accordingly, the flowchart in FIG. 8 describes a process in which the re-output of voice guidance is stopped when the driver expresses an intention to stop voice guidance after the re-output of the voice guidance, thereby contributing to improving driving convenience and reducing fatigue caused by unnecessary voice guidance.

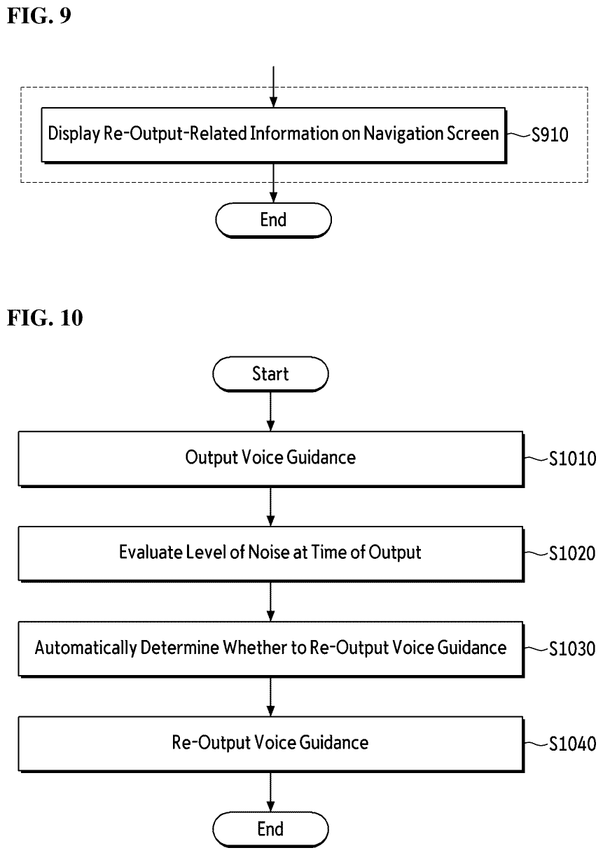

FIG. 9 is a flowchart illustrating a process in which information related to the re-output of voice guidance is displayed on the screen of the navigation terminal after the step or operation S730 in FIG. 7, according to an embodiment of the present disclosure.

FIG. 9 illustrates that visual information regarding the re-output of voice guidance is displayed on the screen of the navigation terminal to help the driver clearly understand the current guidance status.

Referring to FIG. 9, in a step or operation S910, information related to the re-output status of voice guidance may be displayed on the screen of the navigation terminal. This information may include re-output-related content such as the current driving route, the next directional instruction, distance information, and estimated arrival time. In addition, the information may be highlighted on the screen in popup form simultaneously with the re-output of voice guidance, enabling the driver to recognize the content of the voice guidance visually. For example, text or an icon matching the content of the voice guidance may appear on the screen to provide supplementary information regarding the re-output voice guidance.

The visual display function described in FIG. 9 may be effectively used in an environment where voice guidance is difficult to hear or in a situation where the driver cannot fully understand information through voice guidance alone. Through this, the driver may identify re-output information displayed on the screen in addition to voice guidance, resolve uncertainty regarding the route or direction during driving, and support safe, efficient driving.

FIG. 10 is a flowchart illustrating a process in which the navigation terminal automatically determines whether to re-output voice guidance according to an embodiment of the present disclosure.

Referring to FIG. 10, in a step or operation S1010, voice guidance is output. The navigation terminal may deliver information such as route guidance, directional change information, and cautions during driving in the form of voice. The voice guidance may serve an important function by helping the driver follow the route without needing to look at visual information while driving.

In a step or operation S1020, the level of noise at the time of output of the voice guidance may be evaluated. The step or operation S1020 may detect various types of noise occurring inside and outside the vehicle and identify situations where the driver may have difficulty clearly hearing the voice guidance. In an embodiment, the noise may include external noise such as surrounding traffic noise, engine noise, and wind noise, as well as internal noise such as air conditioner noise, audio device noise, and conversation noise from a passenger.

In a step or operation S1030, whether to re-output the voice guidance is determined (e.g., automatically determined) based on the level of noise evaluated in the step or operation S1020. For example, when the voice guidance is determined as not having been clearly heard due to a high noise level, the navigation terminal may decide that re-output of the voice guidance is necessary. In the step or operation S1030, the navigation terminal may further evaluate the passenger's behavior or utterance for a certain period to accurately determine whether voice guidance is needed.

In a step or operation S1040, when it is determined that re-output is necessary, the voice guidance may be re-output. This may support safe driving by allowing the driver to re-confirm information when important guidance has been missed. In addition, related information may be displayed on the screen as a popup along with the re-output of the voice guidance. Through this, the driver may check the content of the voice guidance not only aurally but also visually, reducing confusion during driving.

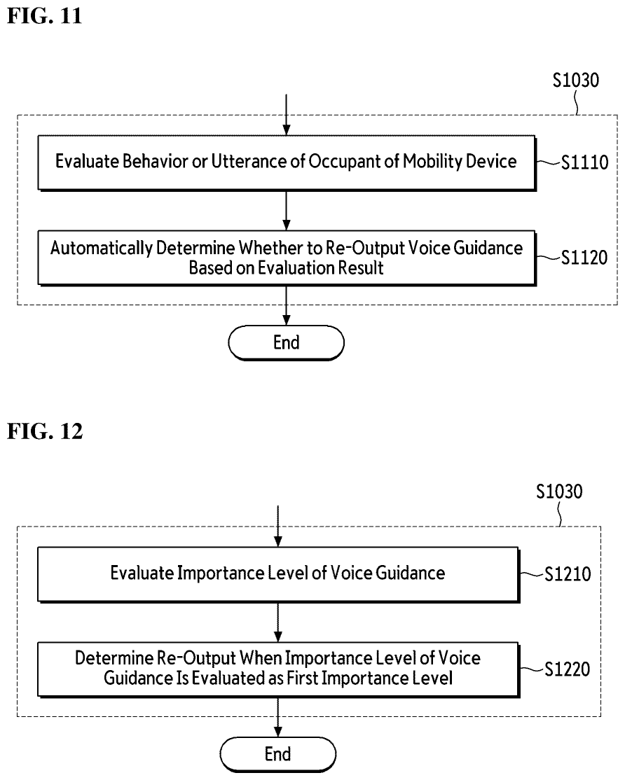

FIG. 11 is a flowchart illustrating the step or operation S1030 in FIG. 10 in more detail, according to an embodiment of the present disclosure.

Referring to FIG. 11, steps or operations S1110 and S1120 may include a process of additionally evaluating the behavior and utterances of the user boarding the mobility device in order to determine whether to re-output voice guidance. The navigation terminal may thus accurately determine whether to re-output voice guidance according to the user's status and needs during driving.

In the step or operation S1110, the behavior or utterances of the user may be evaluated. For example, when the user shows specific behavior such as turning their head or moving their hand, or when a specific utterance is detected, the navigation terminal may determine that re-output of voice guidance is needed. When the driver utters, for example, “Say it again,” “What?,” or “I didn't hear it!” or exhibits a reaction such as frustration or irritation, the navigation terminal may recognize the utterance or reaction and determine that re-guidance is necessary. Especially in a high-noise situation, if the user utters, for example, “Give me the guidance again,” loudly or speaks in an irritated tone, the navigation terminal may determine based on such behavior and utterance that the user has missed voice guidance.

In the step or operation S1120, based on the result of the evaluation performed in the step or operation S1110, whether to re-output voice guidance is automatically determined. If the evaluation result shows that the user is in a situation where the user needs re-guidance, the navigation terminal may automatically re-output voice guidance and deliver necessary information again. Conversely, if it is determined that re-output of voice guidance is not necessary, the existing guidance may be maintained or no additional guidance may be provided. This process allows the navigation terminal to respond appropriately to the situation by reflecting not only the noise environment but also the user's behavior and utterances.

FIG. 12 is a flowchart illustrating the step or operation S1030 in FIG. 10 in more detail, according to another embodiment of the present disclosure.

Referring to FIG. 12, steps or operations S1210 and S1220 include a process of evaluating the importance of voice guidance in order to determine whether to re-output the voice guidance. Through this process, the navigation terminal may determine whether re-output of voice guidance is actually necessary in each situation, and provide voice guidance while prioritizing information related to driving safety.

In the step or operation S1210, the importance of voice guidance may be evaluated. The importance of voice guidance may be determined based on how significantly the voice guidance affects the current driving route. For example, important information such as highway entry or directional guidance at a major intersection may be evaluated as having first-level importance, as it often requires an immediate response from the driver. In contrast, information such as a road name announcement or information near the destination may be evaluated as having lower importance and classified as second-level importance. Second-level importance may be considered relatively less critical, and re-output may not be necessary depending on the situation.

In the step or operation S1220, when the voice guidance is evaluated in the step or operation S1210 as having the first-level importance, the navigation terminal determines to re-output the voice guidance. For example, voice guidance evaluated as having the first-level importance, such as highway entry or complex intersection guidance, may require a real-time response from the driver, and thus, the navigation terminal may automatically re-output the voice guidance to ensure that important information is re-delivered. Conversely, voice guidance evaluated as having the second-level importance may be determined as not requiring re-output, and the navigation terminal may automatically omit re-output. Through this, the driver may accurately grasp important voice guidance without missing it and minimize confusion at a critical point during driving.

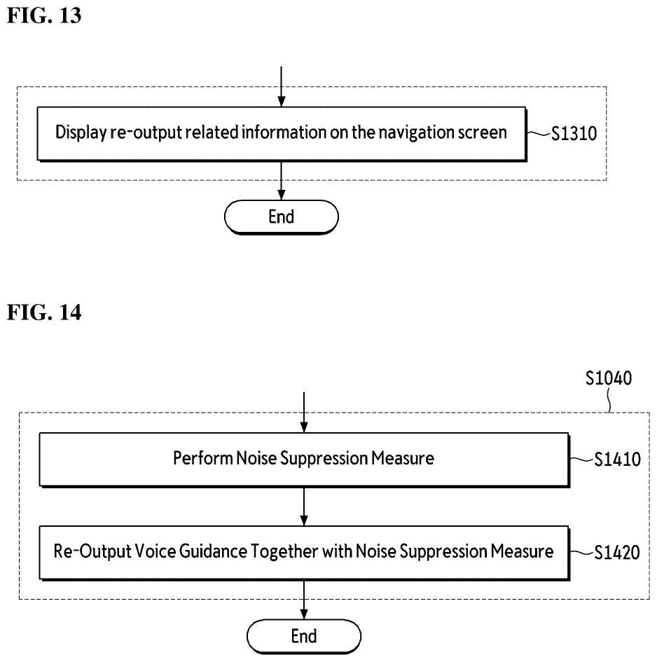

FIG. 13 is a flowchart illustrating the step or operation S1040 in FIG. 10 in more detail, according to an embodiment of the present disclosure.

Referring to FIG. 13, in a step or operation S1310, after voice guidance has been re-output, related information may be displayed on the screen of the navigation terminal.

In the step or operation S1310, re-output-related information may be displayed on the screen. This process may include a function for visually notifying the driver that the voice guidance has been re-output. For example, after the voice guidance has been re-output, a popup message or icon indicating the re-output of the voice guidance may be displayed on the screen. Such a display element may include key information from the re-output voice guidance, such as “Re-guidance in progress: Turn left in 250 meters,” and help the driver re-check an important point on the current route.

In addition, this process may occur only when voice guidance has actually been re-output, regardless of whether the re-output was user-requested or automatically triggered. Through this process, the driver may clearly recognize whether voice guidance has been re-output, and visual feedback may be provided to prevent redundant guidance. The re-output-related information may be set to disappear automatically after a certain period or may be manually dismissed by the driver.

FIG. 14 is a flowchart illustrating the step or operation S1040 in FIG. 10 in more detail, according to another embodiment of the present disclosure.

FIG. 14 illustrates steps or operations in which a noise suppression measure and re-output of voice guidance are performed together.

Referring to FIG. 14, a step or operation S1040 may include a procedure in which a noise suppression measure is performed to create an environment in which voice guidance can be effectively delivered, followed by the re-output of the voice guidance.

In the step or operation S1410, a noise suppression measure is first performed. The noise suppression measure aims to block or minimize external and internal noise. For example, unnecessary external noise may be reduced through a noise canceling function, while internal noise may be suppressed by the vehicle's audio system emitting sounds of specific frequencies to cancel the internal noise. The noise suppression measure may help ensure that the driver does not miss important voice guidance while driving when voice guidance is re-output.

In the step or operation S1420, the voice guidance is re-output simultaneously with the completion of the noise suppression measure. The simultaneous execution of noise suppression and re-output allows the driver to clearly hear the voice guidance even in a noisy driving environment, thereby maximizing the delivery effectiveness of the voice guidance. At this time, the same voice guidance may be re-output, and important information that the driver must not miss, such as route instructions, speed limit information, or hazard warnings may be redelivered.

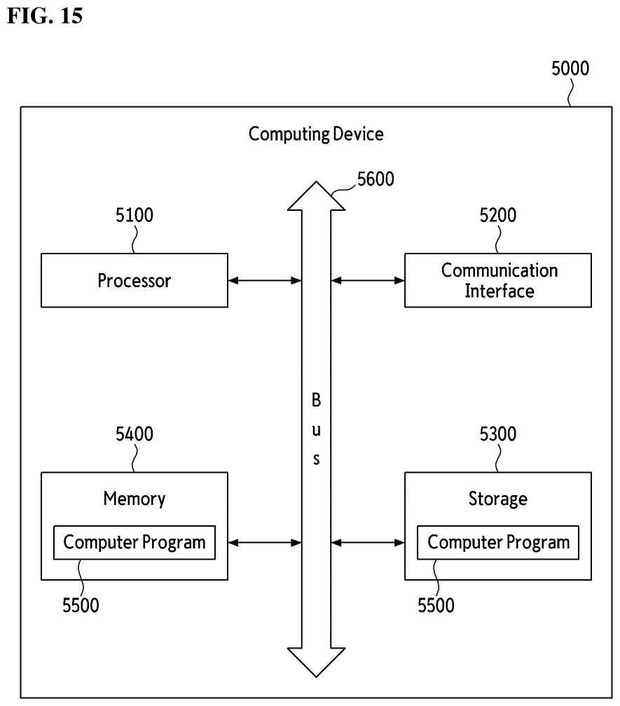

FIG. 15 is a block diagram illustrating the hardware configuration of a computing device for navigation voice guidance according to an embodiment of the present disclosure.

Referring to FIG. 15, a computing device 5000 may include at least one processor 5100, a bus 5600, a communication interface 5200, a memory 5400 that loads a computer program 5500 executed by the processor 5100, and a storage 5300 that stores the computer program 5500. It is noted that only components relevant to the embodiments of the present disclosure are illustrated in FIG. 15.

Therefore, one of ordinary skill in the art should understand that the computing device 5000 may include additional general components beyond those illustrated in FIG. 15. That is, the computing device 5000 may include various additional components other than those depicted in FIG. 15. Also, in some embodiments, some components in FIG. 15 may be omitted from the configuration of the computing device 5000. Below is a description of each component of the computing device 5000, according to an embodiment. In addition, throughout the present disclosure, the terms “computing device 5000” and “computing system” may be used interchangeably.

The processor 5100 may control the overall operation of each component of the computing device 5000. The processor 5100 may include at least one of a central processing unit (CPU), a micro processing unit (MPU), a micro controller unit (MCU), a graphics processing unit (GPU), or any processor form well known in the technical field of the present disclosure. The processor 5100 may perform computations for at least one application or program that executes operations/methods according to various embodiments of the present disclosure. The computing device 5000 may include more than one processor.

The memory 5400 may store various data, commands, and/or information. To execute the operations/methods according to various embodiments of the present disclosure, the memory 5400 may load the computer program 5500 from the storage 5300. The memory 5400 may be implemented as volatile memory such as RAM, but the present disclosure is not limited thereto.

The bus 5600 may provide a communication function between the components of the computing device 5000. The bus 5600 may be implemented in various forms such as an address bus, data bus, and control bus.

The communication interface 5200 may support wired or wireless Internet communication of the computing device 5000. Also, the communication interface 5200 may support various communication methods other than Internet communication. To this end, the communication interface 5200 may include communication modules well known in the technical field of the present disclosure.

The storage 5300 may non-transitorily store one or more computer programs 5500. The storage 5300 may include nonvolatile memory such as ROM, EPROM, EEPROM, flash memory, hard disk, removable disk, or any form of computer-readable recording medium well known in the technical field of the present disclosure.

The computer program 5500 may include one or more computer-readable instructions that, when loaded into the memory 5400 and executed by the processor 5100, cause the processor 5100 to perform the operations/methods according to various embodiments of the present disclosure. The processor 5100 may thus perform the operations/methods according to various embodiments of the present disclosure by executing the loaded one or more instructions.

For example, the computer program (e.g., in the form of computer-readable instructions) 5500 may include instructions to perform the operations of: outputting voice guidance; identifying a first user input based on a predetermined touch input on a touch display; and re-outputting the voice guidance in response to the first user input.

Embodiments of the present disclosure provide a technology that allows voice guidance to be re-output through a simple gesture input when the driver misses the voice guidance. Embodiments of the present disclosure provide a technology that determines (e.g., automatically determines) whether to re-output the voice guidance by analyzing the level of external and internal noise generated in the driving environment. The navigation voice guidance system according to embodiments of the present disclosure, may enhance safety by supplementing in real time important voice guidance that may be missed by the driver and by providing a personalized voice guidance environment that reflects the user's intention, thereby further improving driving convenience.

The navigation voice guidance system according to embodiments of the present disclosure may efficiently determine whether to re-output voice guidance based on the user's real-time driving situation and provide guidance information, thereby maximizing accuracy and convenience in delivering information during driving. The main effects of the present disclosure are as follows.

First, by determining (e.g., automatically determining) whether to re-output voice guidance based on the noise situation and the user's behavior, the driver can be supported in not missing necessary information. The present disclosure can evaluate the level of noise at the time of voice guidance in real time and clearly deliver the voice guidance through a noise suppression measure when necessary. This allows the driver to safely receive route guidance even in environments such as high-speed driving or roads with heavy noise.

Second, by evaluating the user's behavior or utterance to determine whether to re-output voice guidance, personalized voice guidance tailored to the driver's cognitive state can be provided. For example, when an utterance such as “What?” or a behavior expressing frustration is recognized from the user, and it is determined that re-output is necessary, the voice guidance can be provided again. This enables the driver to accurately grasp route guidance without missing it and minimizes unnecessary interruptions during driving by reducing redundant guidance.

Third, by evaluating the importance of voice guidance and determining whether to re-output based on the result of the evaluation, only necessary information can be provided at the right time. The present disclosure can prioritize and re-output high-importance guidance such as major points on a route (e.g., highway entry, major intersections, etc.), while omitting low-importance guidance to improve guidance efficiency. This allows the driver to focus on information actually needed for the route and enhances concentration during driving.

Fourth, by performing a noise suppression measure and voice guidance re-output simultaneously, clear voice guidance can be achieved even in noisy environments. Through the function of blocking external or internal noise and improving clarity of voice guidance, the driver can receive accurate information even in complex environments, contributing to safe driving.

The navigation voice guidance system according to embodiments of the present disclosure enables the driver to clearly perceive route guidance during driving and helps ensure safe and convenient travel to the destination.

The various embodiments and effects of the present disclosure have been described above with reference to FIGS. 1-15. The effects according to the technical spirit of the present disclosure are not limited to those described above. Other effects not mentioned should be more clearly understood by one of ordinary skill in the art from the above description.

Although all components constituting the embodiments of the present disclosure have been described as being combined into one or operating as one, the present disclosure is not necessarily limited to such embodiments. For example, within the scope of the objectives of the present disclosure, all components may selectively operate in combinations of one or more.

Although operations are illustrated in a specific order in the drawings, it should not be understood that the operations must be executed in the specific or sequential order shown, or that all the illustrated operations must be executed to obtain the desired result. In certain situations, multitasking and parallel processing may be advantageous. Furthermore, the separation of various configurations in the embodiments described above should not be understood as mandatory, and it should be understood that the described program components and systems can generally be integrated as a single software product or packaged as multiple software products.

Although the embodiments of the present disclosure have been described above with reference to the accompanying drawings, one of ordinary skill in the art should understand that the present disclosure may be embodied in other specific forms without changing the technical spirit or scope of the present disclosure. Therefore, the embodiments described above should be understood in all respects as illustrative and not limiting. The scope of protection of the present disclosure should be interpreted based on the following claims, and all technical ideas within the equivalent scope should be construed as included in the scope of rights of the present disclosure.

What is claimed is:

1. A navigation voice guidance method performed by a navigation terminal having a touch display, the navigation voice guidance method comprising:
outputting a voice guidance;
identifying a first user input based on a predetermined touch input on the touch display; and
re-outputting the voice guidance in response to the first user input.

2. The navigation voice guidance method of claim 1, wherein identifying the first user input includes:
detecting that a touch input at a first point of the touch display is moved by the user from the first point to a second point located at a lower left side of the first point; and
detecting that the touch input from the second point is moved by the user to a third point located at a lower right side of the second point.

3. The navigation voice guidance method of claim 1, wherein identifying the first user input includes detecting that the user zooms in on a screen of the touch display within a predetermined period after output of the voice guidance.

4. The navigation voice guidance method of claim 1, further comprising:
identifying an intention of a user to stop re-output of the voice guidance; and
stopping the re-output of the voice guidance based on identifying the intention of the user to stop the re-output of the voice guidance,
wherein the intention to stop the re-output of the voice guidance is identified based on a behavior or utterance of an occupant of a mobility device.

5. The navigation voice guidance method of claim 1, further comprising displaying re-output-related information as a popup on a mobility navigation screen together with re-outputting the voice guidance.

6. A navigation voice guidance method performed by a navigation terminal, the navigation voice guidance method comprising:
outputting a voice guidance;
determining a level of noise at a time of the outputting of the voice guidance;
determining whether to re-output the voice guidance based on the level of noise; and
re-outputting the voice guidance based on determining that the voice guidance is to be re-output.

7. The navigation voice guidance method of claim 6, wherein determining whether to re-output the voice guidance includes:
evaluating a behavior or utterance of an occupant of a mobility device equipped with the navigation terminal during a predetermined period from the time of the output of the voice guidance; and
determining whether to re-output the voice guidance based on the behavior or utterance of the occupant and the level of noise.

8. The navigation voice guidance method of claim 6, wherein determining whether to re-output the voice guidance includes:
determining an importance level of the voice guidance; and
determining to re-output the voice guidance based on determining that the importance level of the voice guidance is a first importance level,
wherein:
the importance level includes the first importance level and a second importance level lower than the first importance level, and
the importance level is determined based on a degree of influence on a real-time route.

9. The navigation voice guidance method of claim 6, further comprising:
identifying an intention of a user to stop the re-output of the voice guidance; and
stopping the re-output of the voice guidance based on identifying the intention of the user to stop the re-output of the voice guidance,
wherein the intention to stop the re-output of the voice guidance is identified based on a behavior or utterance of an occupant of a mobility device.

10. The navigation voice guidance method of claim 6, further comprising displaying re-output-related information as a popup on a mobility navigation screen together with the re-output of the voice guidance.

11. The navigation voice guidance method of claim 6, wherein re-outputting the voice guidance includes:
performing a noise suppression measure; and
re-outputting the voice guidance together with the noise suppression measure,
wherein:
the noise includes external noise and internal noise, and
a noise suppression measure for the external noise and a noise suppression measure for the internal noise are distinguishable from each other.

12. A navigation voice guidance system comprising:
at least one processor; and
a memory storing computer-readable instructions that, when executed by the at least one processor, cause the at least one processor to:
output a voice guidance via a navigation terminal;
determine a level of noise at a time of output of the voice guidance;
determine whether to re-output the voice guidance based on the level of noise; and
re-output the voice guidance based on determining that the voice guidance is to be re-output.

13. The navigation voice guidance system of claim 12, wherein the computer-readable instructions, when executed by the at least one processor, case the at least one processor to:
evaluate a behavior or utterance of an occupant of a mobility device equipped with the navigation terminal during a predetermined period from the time of output of the voice guidance; and
determine whether to re-output the voice guidance based on the behavior or utterance of the occupant and the level of noise.

14. The navigation voice guidance system of claim 12, wherein the computer-readable instructions, when executed by the at least one processor, cause the at least one processor to:
determine an importance level of the voice guidance; and
determine to re-output the voice guidance based on determining that the importance level of the voice guidance is a first importance level,
wherein:
the importance level includes the first importance level and a second importance level lower than the first importance level, and
the importance level is determined based on a degree of influence on a real-time route.

15. The navigation voice guidance system of claim 12, wherein the computer-readable instructions, when executed by the at least one processor, further cause the at least one processor to:
identify an intention of a user to stop re-output of the voice guidance; and
stop the re-output of the voice guidance in response to identifying the intention of the user to stop re-outputting the voice guidance,
wherein the intention to stop the re-output of the voice guidance is identified based on a behavior or utterance of an occupant of a mobility device.

16. The navigation voice guidance system of claim 12, wherein the computer-readable instructions, when executed by the at least one processor, further cause the at least one processor to display re-output-related information as a popup on a mobility navigation screen together with the re-output of the voice guidance.

17. The navigation voice guidance system of claim 12, wherein the computer-readable instructions, when executed by the at least one processor, cause the at least one processor to:
perform a noise suppression measure; and
re-output the voice guidance together with the noise suppression measure,
wherein:
the noise includes external noise and internal noise, and
a noise suppression measure for the external noise and a noise suppression measure for the internal noise are distinguishable from each other.
